(19) United States
(12) Patent Application Publication
(10) Pub. No.: US 2026/0127634 A1
(43) Pub. Date: May 7, 2026

(54) DYNAMIC FREQUENCY CAPPING FOR TARGETED CONTENT

(71) Applicant: ADOBE INC., San Jose, CA (US)

(72) Inventors: Prashant DAHIYA, Haryana (IN); Ankur GUPTA, Noida (IN); Ankur DHIR, Uttar Pradesh (IN); Adarshdeep SINGH, Bangalore (IN)

(21) Appl. No.: 18/938,116

(22) Filed: Nov. 5, 2024

(51) Int. Cl. G06Q 30/0242; G06Q 30/0241; G06Q 30/0251

(52) U.S. Cl. CPC G06Q 30/0244; G06Q 30/0249; G06Q 30/0251

(57) ABSTRACT

Methods and systems are provided for dynamic frequency capping for targeted content. In embodiments described herein, target audience exploration engine determines a target audience for content corresponding to a set of target devices for each household of a set of target households. A targeted content platform serves the content to a corresponding household of the set of target households until an exploration budget of a number of impressions is met for the corresponding household or an exploration phase time limit ends for the corresponding household. A budget optimization engine determines an updated target audience by adding a target device to the corresponding set of target devices of the corresponding household or removing the corresponding household to add a new household to the set of target households. The targeted content platform serves the content to the updated target audience.

### BACKGROUND

Advertisers are increasingly utilizing an omnichannel digital marketing strategy where customers are exposed to targeted advertisements over different communication channels to increase the likelihood of conversions. Frequency capping allows advertisers to limit the number of times a user sees the same advertisement in order to prevent overexposure to the advertisement while improving the effectiveness and reach of the advertisement with respect to the marketing budget. Currently, digital marketers manually input a static frequency capping setting that does not change with respect to the user being targeted. As such, the digital marketer must then manually experiment and refine the static frequency capping setting in order to determine the preferred frequency capping setting for the specific marketing campaign.

### SUMMARY

Various aspects of the technology described herein are generally directed to systems, methods, and computer storage media for, among other things, dynamic frequency capping for targeted content. For example, historical customer data is used to generate household graphs mapping groups of devices to particular locations. An influence score is determined for each device of each household corresponding to the likelihood that displaying targeted content to a particular device of a group of devices mapped to a particular household will result in a conversion. A target audience that includes a set of target devices for each household of a set of target households is determined based on the influence score for the set of target devices. During an exploration phase for each household, a targeted content platform serves content to the target audience until an exploration budget is met for the household or a time limit is reached. During an exploitation phase, the set of target devices of the set of target households and the set of target households are updated responsive to each time that: (1) the exploration budget is met for a target household; (2) the exploration phase time limit ends without the exploration budget being met for a target household; (3) an interaction event occurs for a target household after the exploration phase ends for the target household; and/or (4) after a time period ends when a target household received less than a threshold number of impressions. In this regard, the targeted content platform serves content to the updated target audience to increase the likelihood of conversions.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a diagram of an environment in which one or more embodiments of the present disclosure can be practiced, in accordance with various embodiments of the present disclosure.

FIG. 2 depicts an example configuration of an operating environment in which some implementations of the present disclosure can be employed, in accordance with various embodiments of the present disclosure.

FIG. 3 provides an example diagram of an architecture for implementing dynamic frequency capping for targeted digital advertisements, in accordance with embodiments of the present disclosure.

FIGS. 4 and 5 provide example diagrams of generating household graphs for implementing dynamic frequency capping for targeted digital advertisements, in accordance with embodiments of the present disclosure.

FIG. 6 is a process flow showing a method for implementing dynamic frequency capping for targeted digital advertisements, in accordance with embodiments of the present disclosure.

FIG. 7 is a process flow showing a method for implementing dynamic frequency capping for targeted digital advertisements, in accordance with embodiments of the present disclosure.

FIG. 8 is a process flow showing a method for implementing dynamic frequency capping for targeted digital advertisements, in accordance with embodiments of the present disclosure.

FIG. 9 is a block diagram of an example computing device in which embodiments of the present disclosure can be employed.

### DETAILED DESCRIPTION

Various terms are used throughout the description of embodiments provided herein. A brief overview of such terms and phrases is provided here for ease of understanding, but more details of these terms and phrases is provided throughout.

A “customer device” generally refers to an electronic device that is used by a customer where an application operating on the electronic initiates advertisement requests for targeted advertisements. For example, a customer device may refer to a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

A “static device” generally refers to a customer device that does not move from a specific location, such as a house. For example, a static device can be defined as a specific type of device or specific types of devices, such as a connected television (CTV), a PC, and/or the like, and/or a device whose IP address typically remains the same (e.g., for longer than a threshold period of time, changes less than a threshold number of times within a threshold period of time, and/or the like).

A “moving device” generally refers to a customer device that moves from a specific location, such as a house. For example, a moving device can be defined as a specific type of device or specific types of devices, such as a mobile device, a laptop computer, a tablet computer, and/or the like, and/or a device whose IP address typically changes (e.g., within a threshold period of time, changes more than a threshold number of times within a threshold period of time, and/or the like).

An “advertisement platform,” also referred to herein as a “targeted content platform,” generally refers to a platform that stores, delivers, and tracks digital advertisements across different communication channels. The advertisement platform can determine advertisements to show to a specific customer and/or customer device based on customer data, targeting criteria, bidding strategies, and/or any criteria of an advertisement campaign. The advertisement platform can also track performance metrics, such as impressions, clicks, conversions, and/or the like to optimize an advertisement campaign. An example of an advertisement platform is Adobe® Advertising Cloud (AdCloud).

A “household graph” generally refers to a data structure mapping a group of devices to a single location (e.g., household), such as a common network. For example, a household may include a number of static devices and a number of moving devices. The static devices can include the CTV's, appliances, entertainment systems (e.g., a smart speaker), and/or the like in the household. The moving devices can include the mobile devices, such as the smartphones, of each member of the household (e.g., each family member, roommate, and/or the like). Each of the static devices and moving devices of the household can be mapped to a particular household graph. A household graph can be identified by a corresponding household identifier (“household ID”).

An “influence score” generally refers to the likelihood that displaying a targeted advertisement to a particular device of a group of devices mapped to a particular household graph will result in a conversion. For example, a particular mobile device may have higher influence score with respect to a different device mapped to the same household graph based on historical customer data for the particular mobile device indicating prior purchases through the mobile device. In certain embodiments, the influence score of each device of the group of devices of the particular household graph is determined with respect to marketing campaign categories, such as a sports category, a furniture category, a gaming category, an electronics category, and/or the like. For example, a particular device may have higher influence score for a sports category and a lower influence score for a furniture category based on historical customer data for the particular device. As such, advertisements from a sports marketing campaign can be shown to the particular device whereas advertisements from the furniture category would not be shown to the particular device.

A “device identifier” generally refers to a unique string of characters assigned to a specific device to recognize and manage devices. Examples of device identifiers include a connected television identifier (“CTV ID”), an experience cloud identification (“ECID”) used across Adobe Experience Platform and Adobe Experience Cloud applications, a media access control (“MAC”) address, an international mobile equipment identity (“IMEI”), a unique device identifier (“UDID”), a universally unique identifier (“UUID”), an identifier for advertisers (“IDFA”), a Google advertising identifier (“GAID”), an Android advertising identity (“AAID”), a hypertext transfer protocol (HTTP) cookie, and other device identifiers.

“Customer data” refers to any data regarding a customer or customers. Customer data within a dataset may include, by way of example and not limitation, data that is sensed or determined from one or more sensors, such as location information of mobile device(s), smartphone data (such as phone state, charging data, date/time, or other information derived from a smartphone), activity information (for example: app usage; online activity; searches; browsing certain types of webpages; listening to music; taking pictures; voice data such as automatic speech recognition; activity logs; communications data including calls, texts, instant messages, and emails; website posts; other user data associated with communication events) including activity that occurs over more than one device, user history, session logs, application data, contacts data, calendar and schedule data, notification data, social network data, news (including popular or trending items on search engines or social networks), online gaming data, ecommerce activity, including customer journey data, sports data, health data, customer demographics, customer's geographical location, economic status, customer gender, customer age, or any other relevant demographic data collected regarding the customer, and nearly any other source of data that may be used to identify the customer.

An “impression event” generally refers to when marketing content, such as an advertisement, is displayed to a user on a device (e.g., regardless of whether the user interacts with the advertisement). An “interaction event” generally refers to when a user interacts with marketing content, such as an advertisement, on a device (e.g., following an impression event). For example, an interaction event can refer to steps of a conversion funnel, such as a clicking an advertisement, adding a product to a cart, a conversion (e.g., purchasing a product), and/or any event that represents user engagement with the advertisement. In certain embodiments, each type of interaction event can be assigned a different weight with respect to the importance of the type of interaction event. For example, a conversion event will be assigned a higher weight than a click event.

### Overview

As described above, advertisers are increasingly utilizing an omnichannel digital marketing strategy where customers are exposed to targeted advertisements over different communication channels to increase the likelihood of conversions. For example, businesses often collect customer data from different communication channels, such as web applications, mobile applications, email, short message service (“SMS”), social media platforms, call centers and/or other communication channels, and provide targeted advertisements to the customer through the different communication channels. For example, when a customer navigates to a product on a website via a web application through their mobile device, the business may collect a device identifier, such as an IDFA, and an IP address. When the user navigates to an application on their CTV, the application can send a request for an advertisement, including the CTV ID and the IP address, and a targeted advertisement for the product can be sent application on the CTV.

Frequency capping allows advertisers to limit the number of times a user sees the same advertisement in order to prevent overexposure to the advertisement while improving the effectiveness and reach of the advertisement with respect to the marketing budget. Currently, digital marketers manually input a static frequency capping setting that does not change with respect to the user being targeted. As such, the digital marketer must then manually experiment and refine the static frequency capping setting in order to determine the preferred frequency capping setting for the specific marketing campaign.

Accordingly, unnecessary computing resources are utilized to manually refine a static frequency capping setting in conventional implementations. For example, computing and network resources are unnecessarily consumed in an effort to facilitate manually refining a static frequency capping setting as the advertiser must initiate multiple advertising campaigns based on different manually input static frequency capping settings in order to manually refine the static frequency capping setting. For instance, computer input/output operations are unnecessarily increased in order to initiate multiple advertising campaigns based on different manually input static frequency capping settings in order to manually refine the static frequency capping setting as each advertising campaign requires a significant amount of computer input/output operations related to serving advertisements. Further, as the advertising campaigns are communicated over a network, initiating multiple advertising campaigns based on different manually input static frequency capping settings in order to manually refine the static frequency capping setting, decreases the throughput for the network, increases the network latency, and increases packet generation costs.

As such, embodiments of the present disclosure are directed to dynamic frequency capping for targeted digital advertisements in an efficient and effective manner. By determining households and particular devices of each household with a high likelihood of conversion and dynamically adjusting the households and the particular devices of each household during the marketing campaign, the performance of the marketing campaign can be efficiently and effectively improved. For example, the advertiser can increase the return on investment of the omnichannel marketing campaign by lowering the cost per acquisition, lowering the cost per click, lowering the cost per view, and improving the overall cost per unique reach without compromising the campaign performance.

Generally, and at a high level, embodiments described herein facilitate dynamic frequency capping for targeted digital advertisements. For example, historical customer data is used to generate household graphs mapping groups of devices to particular locations. An influence score is determined for each device of each household corresponding to the likelihood that displaying a targeted advertisement to a particular device of a group of devices mapped to a particular household will result in a conversion. A target audience that includes a set of target devices for each household of a set of target households is determined based on the influence score for the set of target devices. During an exploration phase for each household, an advertisement platform serves advertisements to the target audience until an exploration budget is met for the household or a time limit is reached. During an exploitation phase, the set of target devices of the set of target households and the set of target households are updated responsive to each time that: (1) the exploration budget is met for a target household; (2) the exploration phase time limit ends without the exploration budget being met for a target household; (3) an interaction event occurs for a target household after the exploration phase ends for the target household; and/or (4) after a time period ends when a target household received less than a threshold number of impressions. In this regard, the advertisement platform serves advertisements to the updated target audience to increase the likelihood of conversions for the marketing campaign.

In operation, a household graph generation engine generates household graphs mapping groups of devices to particular locations (e.g., households), such as common networks. For example, each household may include a number of static devices and a number of moving devices. The static devices can include the CTV's, appliances, entertainment systems (e.g., a smart speaker), and/or the like in the household. The moving devices can include the mobile devices, such as the smartphones, of each member of the household (e.g., each family member, roommate, and/or the like). Each of the static devices and moving devices of the household can be mapped to a particular household graph. In certain embodiments, household graph generation engine initially generates the household graphs based on historical customer data and periodically (e.g., daily, weekly, monthly, and/or the like) updates the household graphs based on updates to the customer data.

In certain embodiments, a household graph for a particular household can be generated based on historical customer data for each of the devices of the household. For example, when a customer accesses an application (e.g., a website) via a device, customer data, such as interactions with the website, the device identity of the device and IP address assigned to the device, can be collected and stored in a customer data source. As another example, the customer data can be included in a request to an advertisement platform and subsequent customer data, such as an impression event and/or interaction event with the advertisement, device identity of the device and IP address assigned to the device, can be collected and stored in the customer data source.

In certain embodiments, household graph generation engine initially determines each corresponding household graph by mapping static devices to common IP addresses for corresponding time windows. Subsequently, household graph generation engine maps moving devices to each corresponding household graph based on a maximum correlation between each moving device to the common IP addresses for corresponding overlapping time windows. For example, a household graph can be generated that includes a first CTV (e.g., a static device) and a second CTV (e.g., a static device) when customer data for a first CTV indicates that the first CTV was connected to a particular IP address at a specific time and date and customer data for a second CTV indicates that the second CTV was connected to the particular IP address at the specific time and date. A smartphone (e.g., a moving device) can be added to the household graph when customer data for the smartphone indicates that the smartphone was connected to the same IP addresses as the first CTV and/or second CTV more often than other IP addresses.

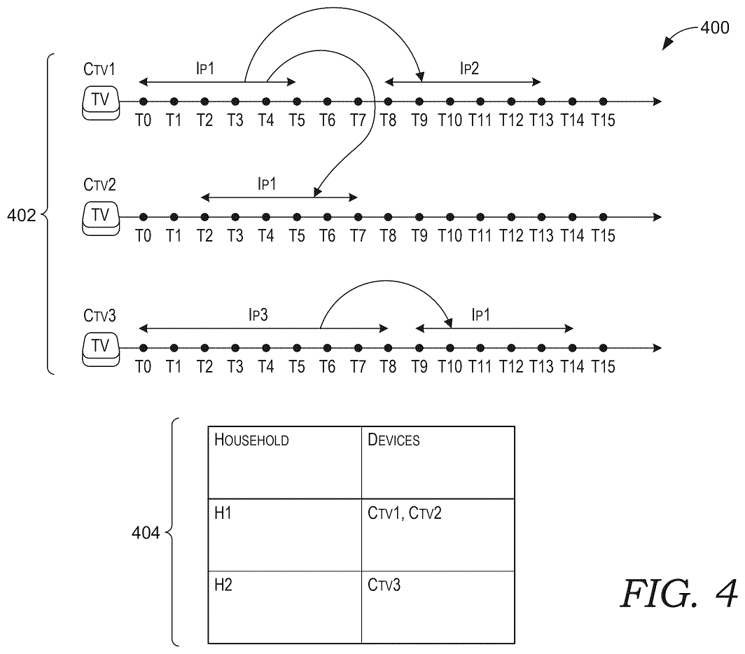

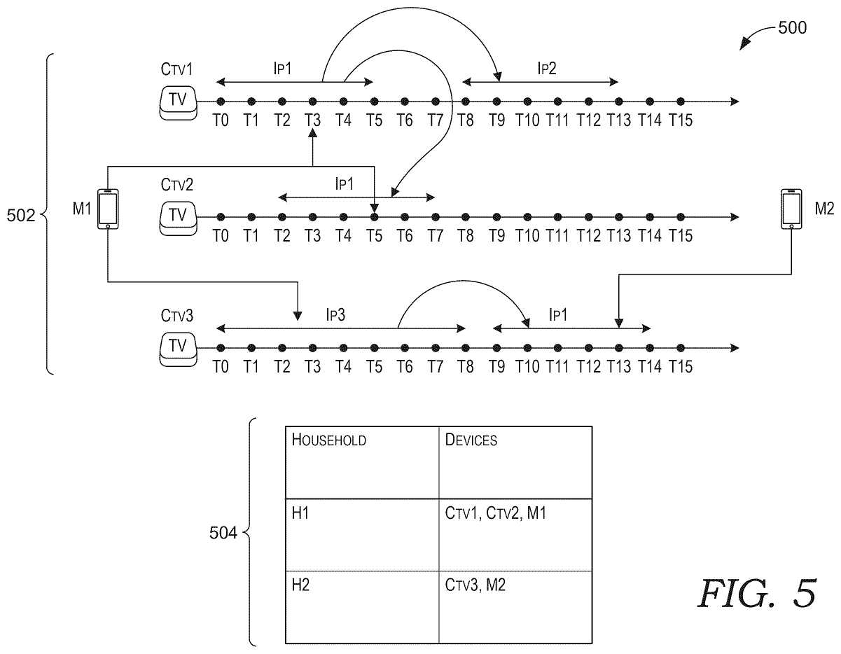

In certain embodiments, household graph generation engine generates a timeline graph for each device from historical customer data indicating each time window that the particular device was connected to a particular IP address. Examples of timeline graphs are shown in FIGS. 4-5.

In certain embodiments, based on the timeline graph for each static device, household graph generation engine generates (1) nodes, where each node corresponds to the time window that the particular static device was connected to a particular IP address, and (2) edges, where each edge indicates a relationship between different IP addresses based on a common static device identifier and/or a relationship between different static device identifiers based on an overlapping time window for the same IP address. Household graph generation engine generates the household graphs based on the nodes of the static devices that are connected by corresponding edges. An example of generating household graphs based on static devices is shown in FIG. 4.

In certain embodiments, based on the timeline graph for each mobile device, household graph generation engine generates (1) nodes, where each node corresponds to the time window that the particular mobile device was connected to a particular IP address, and (2) edges, where each edge indicates a relationship between the moving device and different static device identifiers based on an overlapping time window for the same IP address and/or a relationship between different IP addresses based on a common moving device identifier. Household graph generation engine adds moving devices to corresponding household graphs based on a maximum correlation between the edges connecting a corresponding node of a corresponding moving device to corresponding nodes of the static devices of a corresponding household graph. An example of adding moving devices to corresponding household graphs generated from static devices is shown in FIG. 5.

Based on historical customer data for each of the devices of each of the household graphs, household influence determination engine determines an influence score for each device corresponding to the likelihood that displaying a targeted advertisement to a particular device of a group of devices mapped to a particular household (e.g., household graph corresponding to the household) will result in a conversion. For example, a particular mobile device may have higher influence score with respect to a different device mapped to the same household graph based on historical customer data for the particular mobile device indicating prior purchases through the mobile device. In certain embodiments, household influence determination engine initially generates the influence score based on historical customer data and periodically (e.g., daily, weekly, monthly, and/or the like) updates the influence score based on updates to the customer data.

In certain embodiments, for interactions events, each step of a conversion funnel, such as clicking a product, adding a product to a cart, purchasing a product is weighted differently, and the influence score of a device is determined based on the interaction events on a corresponding device with respect to the steps of the conversion funnel. In certain embodiments, the influence score of each device of the group of devices of the particular household graph is determined with respect to marketing campaign categories, such as a sports category, a furniture category, a gaming category, an electronics category, and/or the like. For example, a particular device may have higher influence score for a sports category and a lower influence score for a furniture category based on historical customer data for the particular device.

Target audience exploration engine generally determines a target audience that includes a set of target devices for each household of a set of target households based on the influence score for the set of target devices. Target audience exploration engine causes an advertisement platform to serve advertisements to the target audience in an exploration phase for each household until an exploration budget is met for the household and/or within a time limit, referred to herein as “an exploration phase time limit.” In this regard, the exploration phase for one household may end at a different time than a different household. For example, an advertiser inputs (1) a frequency cap of ten (10) impressions per household (e.g., a household-level maximum frequency cap), (2) an exploration budget of 30%, and (3) and an exploration phase time limit of one week. In this example, target audience exploration engine causes the advertisement platform to serve advertisements to the target devices of each household until the exploration budget of three (3) impressions is met for a household (and/or the period of time is over). The exploration phase for a first household may end on the first day after three (3) impressions are shown to the target devices of the first household whereas the exploration phase for a second household may end at the end of the week of the exploration phase time limit as only one (1) impression was shown to a target device of the second household.

In certain embodiments, household target device selection engine determines a set of target households to send an advertisement based on the corresponding devices mapped to the household graph of the household. In certain embodiments, household device selection engine determines the set of target households corresponding to a threshold number of households with the highest likelihood of conversion based on historical customer data of the corresponding devices mapped to the household graph of the household. In certain embodiments, the likelihood of conversion is determined with respect to the marketing campaign category of the advertisement.

In certain embodiments, household device selection engine determines a set of target devices for each household of the set of target households to send the advertisement based on the influence score for each device. In certain embodiments, household device selection engine sorts the devices within each household based on the influence score for each device. Household device selection engine then selects a number of devices from each household based on the summation of the influence scores of each device of the number of devices meeting a threshold cumulative influence score. For example, if the threshold cumulative influence score for each household is set to 50%, (1) for a first household, a device of the first household with an influence score of 60% can be selected as the set of target devices and (2) for a second household, a first device of the second household with an influence score of 30% and a second device of the second household with an influence score of 20% can be selected as the set of target devices. In this regard, the number of devices for the set of target devices can be different for each household of the set of target households.

In certain embodiments, the number of devices for each household can be capped by household device selection engine so that a maximum number of devices are selected for each household. Household device selection engine can determine the number of devices for each household and/or the threshold cumulative influence score based on frequency capping parameters, daily budget for a number of advertisements to be sent, and/or the like.

In certain embodiments, target audience exploration engine determines a percentage of the exploration budget of a household assigned to a particular target device, referred to herein as “a device-level exploration frequency cap,” for each device of a set of target devices for each household of the set of target households. For example, in certain embodiments, the percentage of the exploration budget of a household assigned to a first target device of the household with a greater influence score may be greater than the percentage of the exploration budget of the household assigned to a second target device of the household with a lower influence score. In this regard, as an example, with an exploration budget of three (3) impressions for a household, the first target device may have a device-level exploration frequency cap of two (2) impression whereas the second target device may have a device-level exploration frequency cap of one (1) impression.

In certain embodiments, target audience exploration engine determines the device-level exploration frequency cap based on parameters, such as the (1) exploration budget, (2) a maximum number of times the advertisement can be provided to a household by the advertisement platform, referred to herein as a “household-level maximum frequency cap,” (3) a maximum number of times the advertisement can be provided to a particular device by the advertisement platform, referred to herein as a “device-level maximum frequency cap,” and/or (4) the influence score of a device with respect to the cumulative influence score of the set of target devices of the household (e.g., based on a sum of the influence scores of the set of target devices of the household with respect to the influence score of the target device).

In certain embodiments, based on the device-level exploration frequency cap, target audience exploration engine causes an advertisement platform to serve advertisements to each target device of each household of the set of target households until an exploration budget is met for the household and/or until the exploration phase time limit ends for the household. In this regard, as described above, the exploration phase for one household may end at a different time than a different household.

Budget optimization engine updates the set of target devices of the set of target households and/or the set of target households in response to a triggering condition, such as (1) the exploration budget being met for a target household, (2) the exploration phase time limit ending without the exploration budget being met for a target household, (3) an interaction event with respect to the advertisement after the exploration phase ends for a target household (e.g., after exploration budget is met and/or after the exploration phase time limit ends for the household), and/or (4) periodically. For example, budget optimization engine can add or remove target devices from a target household and/or add or remove target households based on aggressiveness of the marketing campaign corresponding to parameters, such as optimization goals, frequency cap, campaign budget, and/or the like. In certain embodiments, budget optimization engine causes the advertisement platform to serve advertisements to an updated target audience to increase the likelihood of conversion of the marketing campaign. For example, the budget optimization engine continues to update the target audience until the time limit for the marketing campaign, referred to herein as “a marketing campaign time limit,” for the advertisement ends.

In certain embodiments, dynamic update engine updates the set of target devices of the set of target households and/or the set of target households in response to a triggering condition, such as (1) the exploration budget being met for a target household, (2) the exploration phase time limit ending without the exploration budget being met for a target household and/or (3) an interaction event with respect to the advertisement after the exploration phase ends for the target household. For example, after the exploration budget is met for a target household, the dynamic update engine is triggered to determine whether to (1) add or remove target devices from the target household and/or (2) remove the target household and add a new household to the set of target households. As another example, if a customer clicks on an advertisement through a target device that received the advertisement from the advertisement platform after the exploration phase ends for a household, the dynamic update engine is triggered to determine whether to (1) add or remove target devices from a target household and/or (2) remove the target household and add a new household to the set of target households.

In certain embodiments, dynamic update engine updates the set of target devices of the set of target households and/or the set of target households in response to (1) the exploration budget being met for a target household or (2) the exploration phase time limit ending without the exploration budget being met for the target household. Initially, dynamic update engine determines the household ID of the target household. Dynamic update engine then determines whether to add or remove devices from the target household associated with the household ID based on the influence score of the devices involved with interaction events with respect to the influence score of the devices that received impressions.

In some embodiments, the new household to add is determined by dynamic update engine as the household with the next highest likelihood of conversion (e.g., as determined by household device selection engine) that was not previously included in the set of target households. In some embodiments, the new household to add is determined by dynamic update engine based on similarity of the new household with households from the set of target households that resulted in a conversion during the exploration phase, such as similar influence scores of devices associated with the household graph of the new household to the households that resulted in a conversion, a similar configuration of devices types associated with the household graph of the new household to the households that resulted in a conversion, and/or the like.

In certain embodiments, dynamic update engine updates the set of target devices of the set of target households and/or the set of target households in response to an interaction event with respect to the advertisement after the exploration phase ends for a target household. Initially, dynamic update engine determines the household ID of the device that triggered the interaction event (e.g., device on which the advertisement was clicked). Dynamic update engine then determines whether to add or remove devices from the household associated with the household ID based on the influence score of the device involved with the interaction event with respect to the influence score of the devices that received impressions.

In certain embodiments, periodic update engine updates the set of target devices of the set of target households periodically. In certain embodiments, for each household that did not receive a threshold number of impressions within a period of time (e.g., daily, weekly and/or the like), referred to herein as a “threshold household impression time limit,” periodic update engine adds additional target devices to the set of target devices of the target household to update the target audience. For example, additional target devices can be added to the set of target devices of the target household to increase the likelihood of a conversion by the target household when the target household has not received enough impressions in a certain amount of time (e.g., during the exploitation phase for the target household).

Advantageously, efficiencies of computing and network resources can be enhanced using implementations described herein. In particular, by determining households and particular devices of each household with a high likelihood of conversion and dynamically adjusting the households and the particular devices of each household provides for a more efficient use of computing resources (e.g., less computationally expensive, less input/output operations, higher throughput and reduced latency for a network, less packet generation costs, etc.) than conventional methods that require an advertiser to initiate multiple advertising campaigns based on different manually input static frequency capping settings in order to manually refine the static frequency capping setting. In this regard, the technology described herein enables dynamic frequency capping for targeted digital advertisements in an efficient and effective manner, thereby reducing unnecessary computing resources used to initiate multiple advertising campaigns based on different manually input static frequency capping settings in order to manually refine the static frequency capping setting. Further, the technology described herein conserves network resources, which results in higher throughput, reduced latency and less packet generation costs as fewer packets are sent over the network.

### Overview of Exemplary Environments of Dynamic Frequency Capping for Targeted Digital Advertisements

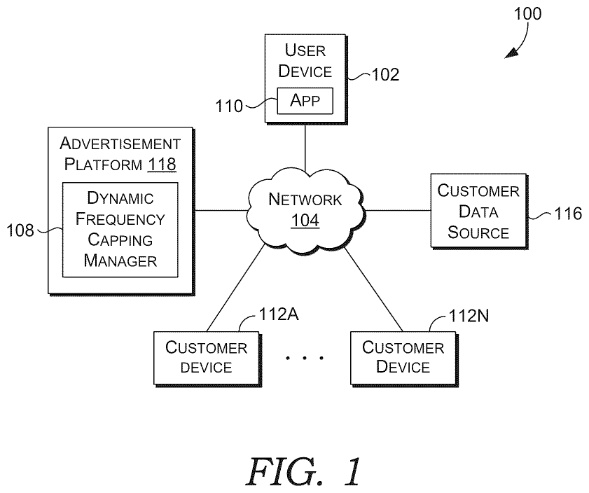

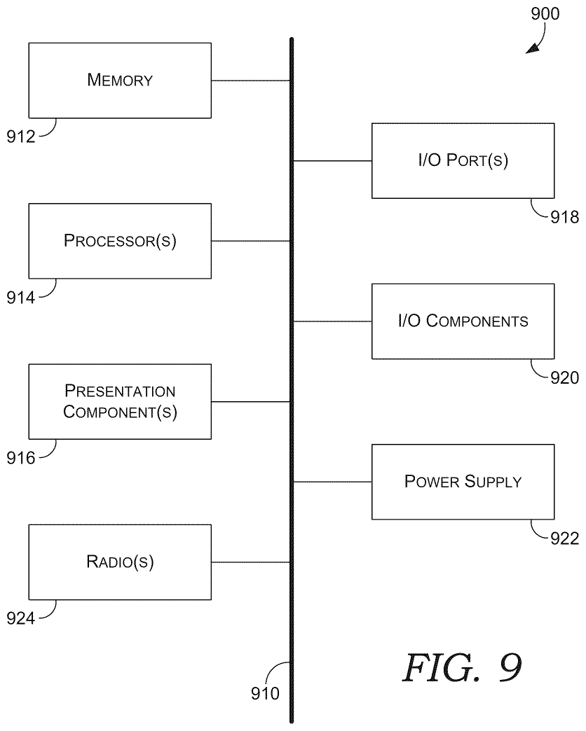

Turning to the figures, FIG. 1 depicts an example configuration of an operating environment in which some implementations of the present disclosure can be employed. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory as further described with reference to FIG. 9.

It should be understood that operating environment 100 shown in FIG. 1 is an example of one suitable operating environment. Among other components not shown, operating environment 100 includes a user device 102, application 110, customer devices 112A-112N, customer data source 116, network 104, advertisement platform 118, and dynamic frequency capping manager 108. Each of the components shown in FIG. 1 can be implemented via any type of computing device, such as one or more of computing device 900 described in connection to FIG. 9, for example.

These components can communicate with each other via network 104, which can be wired, wireless, or both. Network 104 can include multiple networks, or a network of networks, but is shown in simple form so as not to obscure aspects of the present disclosure. By way of example, network 104 can include one or more wide area networks (WANs), one or more local area networks (LANs), one or more public networks such as the Internet, one or more private networks, one or more cellular networks, one or more peer-to-peer (P2P) networks, one or more mobile networks, or a combination of networks. Where network 104 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 104 is not described in significant detail.

It should be understood that any number of user devices, servers, and other components can be employed within operating environment 100 within the scope of the present disclosure. Each can comprise a single device or multiple devices cooperating in a distributed environment.

User device 102 can be any type of computing device capable of being operated by an individual(s) (e.g., an advertiser, any user implementing marketing campaigns on behalf of a business, and/or the like). For example, in some implementations, such devices are the type of computing device described in relation to FIG. 9. By way of example and not limitation, user devices can be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

Customer devices 112A-N can be any type of computing device capable of being operated by an individual(s) (e.g., a customer interacting with applications on the customer device to which the targeted advertisement is displayed). For example, in some implementations, such devices are the type of computing device described in relation to FIG. 9. By way of example and not limitation, user devices (e.g., customer devices) can be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 and/or customer devices 112A-N can include one or more processors, and one or more computer-readable media. The computer-readable media may include computer-readable instructions executable by the one or more processors. The instructions may be embodied by one or more applications, such as application 110 shown in FIG. 1. Application 110 is referred to as a single applications for simplicity, but its functionality can each be embodied by one or more applications in practice.

Application 110 operating on user device 102 can generally be any application capable of facilitating the exchange of information between the user device 102 and advertisement platform 118 and dynamic frequency capping manager 108 in displaying and exchanging information regarding implementing marketing campaigns to send targeted advertisements customer devices 112A-N. In some implementations, the application 110 comprises a web application, which can run in a web browser, and could be hosted at least partially server-side (e.g., via dynamic frequency capping manager 108). In addition, or instead, the application 110 can comprise a dedicated application. In some cases, the application 110 is integrated into the operating system (e.g., as a service). It is therefore contemplated herein that “application” be interpreted broadly.

User device 102 can be a client device on a client-side of operating environment 100, while advertisement platform 118 and dynamic frequency capping manager 108 can be on a server-side of operating environment 100. Advertisement platform 118 and/or dynamic frequency capping manager 108 may comprise server-side software designed to work in conjunction with client-side software on user device 102 so as to implement any combination of the features and functionalities discussed in the present disclosure. An example of such client-side software is application 110 on user device 102. This division of operating environment 100 is provided to illustrate one example of a suitable environment, and it is noted there is no requirement for each implementation that any combination of user device 102, advertisement platform 118, or dynamic frequency capping manager 108 to remain as separate entities.

In operation, as described herein, dynamic frequency capping manager 108 uses historical customer data stored in customer data source 116 to generate household graphs mapping groups of devices to particular locations. Dynamic frequency capping manager 108 determines an influence score for each device of each household graph corresponding to the likelihood that displaying a targeted advertisement to a particular device of a group of devices mapped to a particular household will result in a conversion. Dynamic frequency capping manager 108 determines a target audience that includes a set of target devices (e.g., from customer devices 112A-N) for each household of a set of target households based on the influence score for the set of target devices. During an exploration phase for each household, dynamic frequency capping manager 108 causes advertisement platform 118 to serve advertisements to the target audience of customer devices 112A-N until an exploration budget is met for the household or a time limit reached. Dynamic frequency capping manager 108 updates the set of target devices of the set of target households and the set of target households are updated responsive to each time that: (1) the exploration budget is met for a target household; (2) the exploration phase time limit ends without the exploration budget being met for a target household; (3) an interaction event occurs for a target household after the exploration phase ends for the target household; and (4) after a time period ends when a target household received less than a threshold number of impressions. In this regard, dynamic frequency capping manager 108 causes advertisement platform 118 to serve advertisements to the updated target audience of customer devices 112A-N to increase the likelihood of conversions for the marketing campaign.

At a high level, advertisement platform 118 serves targeted advertisements and dynamic frequency capping manager 108 performs various functionality to facilitate efficient and effective dynamic frequency capping for targeted digital advertisements. The dynamic frequency capping manager 108 can communicate with application 110 in order for a user to configure various parameters of a marketing campaign through application 110 via a display screen of the user device 102. Advertisement platform 118 and/or dynamic frequency capping manager 108 can communicate with customer devices 112A-N in order to facilitate efficient and effective dynamic frequency capping for targeted digital advertisements.

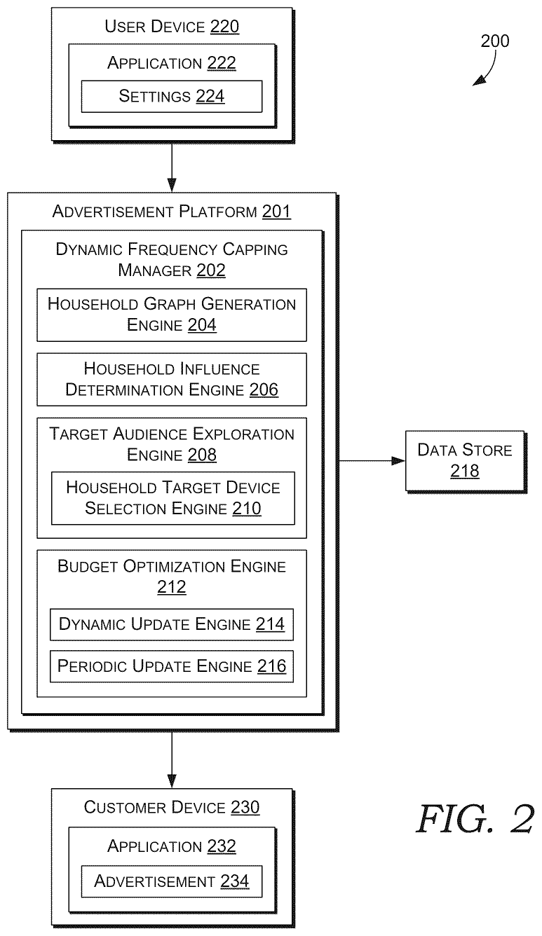

Dynamic frequency capping manager 108 can be or include a server, including one or more processors, and one or more computer-readable media. The computer-readable media includes computer-readable instructions executable by the one or more processors. The instructions can optionally implement one or more components of dynamic frequency capping manager 108, described in additional detail below with respect to dynamic frequency capping manager 202 of FIG. 2. For cloud-based implementations, the instructions on dynamic frequency capping manager 108 can implement one or more components, and application 110 can be utilized by a user to interface with the functionality implemented on dynamic frequency capping manager 108. In some cases, application 110 comprises a web browser. In other cases, dynamic frequency capping manager 108 may not be required. For example, the components of dynamic frequency capping manager 108 may be implemented completely on a user device, such as user device 102. In this case, dynamic frequency capping manager 108 may be embodied at least partially by the instructions corresponding to application 110.

Thus, it should be appreciated that dynamic frequency capping manager 108 may be provided via multiple devices arranged in a distributed environment that collectively provide the functionality described herein. Additionally, other components not shown may also be included within the distributed environment. In addition, or instead, dynamic frequency capping manager 108 can be integrated, at least partially, into a user device, such as user device 102. Furthermore, dynamic frequency capping manager 108 may at least partially be embodied as a cloud computing service.

Referring to FIG. 2, aspects of an illustrative dynamic frequency capping management system 200 are shown, in accordance with various embodiments of the present disclosure. At a high level, the dynamic frequency capping management system 200 facilitates dynamic frequency capping for targeted digital advertisements in an efficient and effective manner.

As shown in FIG. 2, advertisement platform 201 includes dynamic frequency capping manager 202. Dynamic frequency capping manager 202 includes household graph generation engine 202, household influence determination engine 206, target audience exploration engine 208, household target device selection engine 210, budget optimization engine 212, dynamic update engine 214, and periodic update engine 216. Generally, a user (e.g., an advertiser) inputs settings 224 with respect to the dynamic frequency capping manager 202, such as exploration budget, the exploration phase time limit, and/or the like, via application 222 (e.g., application 110 of FIG. 1). Dynamic frequency capping manager 202 causes advertisement platform 201 to send advertisement 234 to application 232 of customer device 230 (e.g., customer devices 112A-N of FIG. 1).

The advertisement platform 201 and dynamic frequency capping manager 202 can communicate with the data store 218. The data store 218 is configured to store various types of information accessible by dynamic frequency capping manager 202, or other server or component. The foregoing components of dynamic frequency capping manager 202 can be implemented, for example, in operating environment 100 of FIG. 1. In particular, those components may be integrated into any suitable combination of user devices 102, customer devices 112A-N, and/or dynamic frequency capping manager 108.

In embodiments, data sources (e.g., data store 218, customer data source 116 of FIG. 1), devices (such as user device 220, customer device 230, user device 102 of FIG. 1 and customer devices 112A-N of FIG. 1), advertisement platform 101, and dynamic frequency capping manager 202 can provide data to the data store 218 for storage, which may be retrieved or referenced by any such component. As such, the data store 218 can store computer instructions (e.g., software program instructions, routines, or services), data and/or models used in embodiments described herein. In some implementations, data store 218 can store information or data received or generated via the various components of advertisement platform 201 and dynamic frequency capping manager 202 and provides the various components with access to that information or data, as needed. The information in data store 218 may be distributed in any suitable manner across one or more data stores for storage (which may be hosted externally).

The household graph generation engine 204 is generally configured to generate household graphs mapping groups of devices to particular locations. In embodiments, household graph generation engine 204 can include rules, conditions, associations, models, algorithms, or the like to generate household graphs. For example, household graph generation engine 204 may comprise a statistical model, fuzzy logic, neural network, finite state machine, support vector machine, logistic regression, clustering, or machine-learning techniques, similar statistical classification processes, or combinations thereof, to generate household graphs.

The household influence determination engine 206 is generally configured to determine an influence score for each device corresponding to the likelihood that displaying a targeted advertisement to a particular device of a group of devices mapped to a particular household (e.g., household graph corresponding to the household) will result in a conversion. In embodiments, household influence determination engine 206 can include rules, conditions, associations, models, algorithms, or the like to determine the influence scores. For example, household influence determination engine 206 may comprise a statistical model, fuzzy logic, neural network, finite state machine, support vector machine, logistic regression, clustering, or machine-learning techniques, similar statistical classification processes, or combinations thereof, to determine the influence scores.

The target audience exploration engine 208, and its subcomponent household target device selection engine 210, are generally configured to determine a target audience corresponding to a set of target devices for each household of a set of target households and cause an advertisement platform to serve advertisements to the target audience in an exploration phase. In embodiments, target audience exploration engine 208 and household target device selection engine 210 can include rules, conditions, associations, models, algorithms, or the like to determine the target audience to serve advertisements to the target audience. For example, target audience exploration engine 208 and household target device selection engine 210 may comprise a statistical model, fuzzy logic, neural network, finite state machine, support vector machine, logistic regression, clustering, or machine-learning techniques, similar statistical classification processes, or combinations thereof, to determine the target audience to serve advertisements to the target audience.

The budget optimization engine 212, and its subcomponents dynamic update engine 214 and periodic update engine 216, are generally configured to update the target audience in response to triggering conditions and cause the advertisement platform to serve advertisements to the updated target audience. In embodiments, budget optimization engine 212, dynamic update engine 214 and periodic update engine 216 can include rules, conditions, associations, models, algorithms, or the like to update the target audience to serve advertisements to the updated target audience. For example, budget optimization engine 212, dynamic update engine 214 and periodic update engine 216 may comprise a statistical model, fuzzy logic, neural network, finite state machine, support vector machine, logistic regression, clustering, or machine-learning techniques, similar statistical classification processes, or combinations thereof, to update the target audience to serve advertisements to the updated target audience.

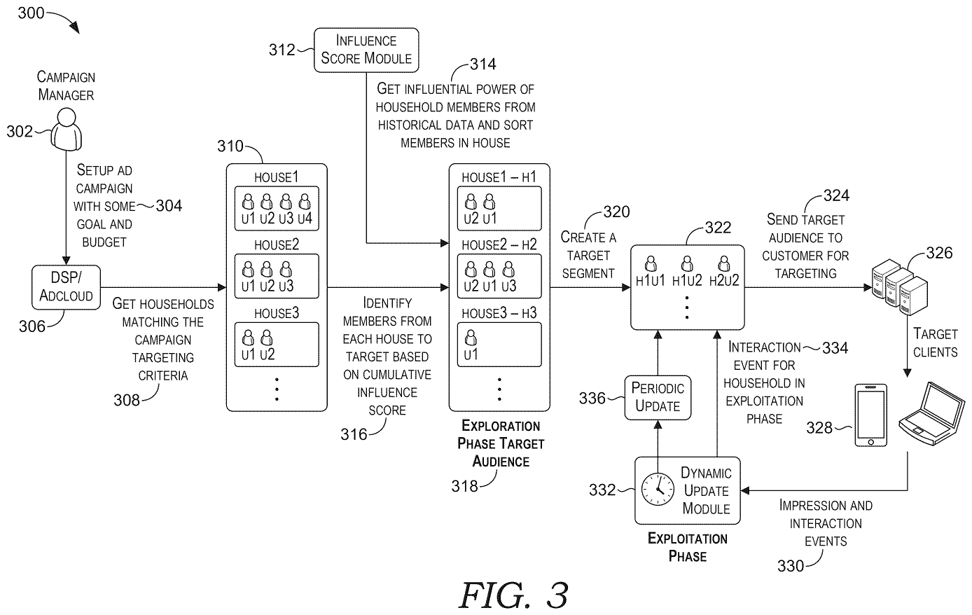

As an overview, FIG. 3 provides example diagram 300 of an architecture for implementing dynamic frequency capping for targeted digital advertisements, in accordance with embodiments of the present disclosure. As can be understood from diagram 300, a campaign manager 302 sets up an advertisement campaign 304 to be implemented via advertisement platform 306 with various settings pertaining to the goal and budget of the advertising campaign 304. Advertisement platform 306 gets the household matching the campaign targeting criteria at block 308 (e.g., based on the marketing campaign category of the advertisement campaign). The devices of corresponding households are determined based on household graphs 310. The influence score module 312 gets the influence power of the household members (e.g., devices) based on historical customer and sorts the members (e.g., devices) of the household based on their respective influence score at block 314. At block 316, the members (e.g., devices) are selected based on a threshold cumulative influence score by determining the highest ranked devices and selecting the devices where the sum of the influence score of the devices meets the threshold cumulative influence score. Based on the selected of devices for each household at block 316, the exploration phase target audience 318 is determined to create the target audience 322 via block 320. At block 324, the target audience is sent to the advertisement platform 326 to send targeted advertisements to the targeted devices 328 in an exploration phase. At block 330, the impression and interactions events 330 are accessed by the dynamic update module 332. Dynamic update module 332 updates the target audience 322 based on the impression and interaction events 330 for each household during the exploitation phase 334. Dynamic update module 332 updates the target audience 322 periodically via periodic update 336.

Returning to FIG. 2, in certain embodiments, a household graph generation engine 204 generates household graphs mapping groups of devices to particular locations (e.g., households), such as common networks, and stores the household graphs in data store 218. In certain embodiments, household graph generation engine 204 initially generates the household graphs based on historical customer data from data store 218 (e.g., customer data source 116 of FIG. 1) and periodically (e.g., daily, weekly, monthly, and/or the like) updates the household graphs based on updates to the customer data.

In certain embodiments, a household graph for a particular household can be generated by household graph generation engine 204 based on historical customer data for each of the devices of the household. For example, when a customer accesses an application 232 (e.g., a website) via customer device 230, customer data, such as interactions with the website, the device identity of the device and IP address assigned to the device, can be collected and stored in a customer data source of data store 218 (e.g., customer data source 116 of FIG. 1). As another example, the customer data can be included in a request to the advertisement platform 201 and subsequent customer data, such as an impression event and/or interaction event with the advertisement 234, device identity of the customer device 230 and IP address assigned to the customer device 230, can be collected and stored in the customer data source of data store 218 (e.g., customer data source 116 of FIG. 1).

In certain embodiments, household graph generation engine 204 initially determines each corresponding household graph by mapping static devices to common IP addresses for corresponding time windows. Subsequently, household graph generation engine 204 maps moving devices to each corresponding household graph based on a maximum correlation between each moving device to the common IP addresses for corresponding overlapping time windows. In certain embodiments, household graph generation engine 204 generates a timeline graph for each device from historical customer data indicating each time window that the particular device was connected to a particular IP address. In certain embodiments, based on the timeline graph for each static device, household graph generation engine 204 generates (1) nodes, where each node corresponds to the time window that the particular static device was connected to a particular IP address, and (2) edges, where each edge indicates a relationship between different IP addresses based on a common static device identifier and/or a relationship between different static device identifiers based on an overlapping time window for the same IP address. Household graph generation engine 204 generates the household graphs based on the nodes of the static devices that are connected by corresponding edges.

An example of generating household graphs based on static devices is shown in FIG. 4. With respect to diagram 400 of FIG. 4, household graph generation engine (e.g., household graph generation engine 204 of FIG. 2) initially determines each corresponding household graph by mapping static devices to common IP addresses for corresponding time windows. As shown in the example timeline graphs 402 of FIG. 4, the household graph generation engine determines (1) a first static device node with data indicating that the static device identifier “CTV1” was connected to IP address “IP1” from time window “T0-T5”; (2) a second static device node with data indicating that the static device identifier “CTV1” was connected to IP address “IP2” from time window “T8-T13;” (3) a third static device node with data indicating that the static device identifier “CTV2” was connected to IP address “IP1” from time window “T2-T7;” (4) a fourth static device node with data indicating that the static device identifier “CTV3” was connected to IP address “IP3” from time window “T0-T8;” and (5) a fifth static device node with data indicating that the static device identifier “CTV3” was connected to IP address “IP1” from time window “T9-T14.” In this regard, the household graph generation engine determines (1) a first static device edge between the first static device node and the second static device node indicating the same static device identifier and (2) a second static device edge between the first static device node and the third static device node indicating an overlapping time window for the same IP address. The household graph generation engine determines the example household graphs 404 based on (1) a first household graph that includes static devices, CTV1 and CTV2 and (2) a second household graph that includes static device CTV3.

Returning to FIG. 2, in certain embodiments, based on the timeline graph for each mobile device, household graph generation engine 204 generates (1) nodes, where each node corresponds to the time window that the particular mobile device was connected to a particular IP address, and (2) edges, where each edge indicates a relationship between the moving device and different static device identifiers based on an overlapping time window for the same IP address and/or a relationship between different IP addresses based on a common moving device identifier. Household graph generation engine 204 adds moving devices to corresponding household graphs based on a maximum correlation between the edges connecting a corresponding node of a corresponding moving device to corresponding nodes of the static devices of a corresponding household graph.

An example of adding moving devices to corresponding household graphs generated from static devices is shown in FIG. 5. With respect to diagram 500 of FIG. 5, after household graph generation engine (e.g., household graph generation engine 204 of FIG. 2) initially determines each corresponding household graph by mapping static devices to common IP addresses for corresponding time windows, the household graph generation engine maps moving devices to each corresponding household graph based on a maximum correlation between each moving device to the common IP addresses for corresponding overlapping time windows. As shown in the example timeline graphs 502 of FIG. 5, after determining the nodes and edges of the static devices in FIG. 4, the household graph generation engine determines (1) a first moving device node with data indicating that the moving device identifier “M1” was connected to IP address “IP3” at time window “T2.5”; (2) a second moving device node with data indicating that the moving device identifier “M1” was connected to IP address “IP1” at time window “T3;” (3) a third moving device node with data indicating that the moving device identifier “M1” was connected to IP address “IP1” at time window “T5;” and (4) a fourth moving device node with data indicating that the moving device identifier “M2” was connected to IP address “IP1” at time window “T13.” In this regard, the household graph generation engine determines (1) a first moving device edge between the first moving device node and the second household graph indicating an overlapping time window for the same IP address; (2) a second moving device edge between the second moving device node and the first household graph indicating an overlapping time window for the same IP address; (3) a third moving device edge between the third moving device node and the first household graph indicating an overlapping time window for the same IP address; and (4) a fourth moving device edge between the fourth moving device node and the second household graph indicating an overlapping time window for the same IP address. The household graph generation engine determines household graphs 504 by (1) adding moving device M1 to the first household graph (e.g., from household graphs 404 of FIG. 4) based on the maximum correlation to the first household graph and (2) adding moving device M2 to the second household graph (e.g., from household graphs 404 of FIG. 4) based on the maximum correlation to the second household graph.

Returning to FIG. 2, based on historical customer data for each of the devices of each of the household graphs, household influence determination engine 206 determines an influence score for each device corresponding to the likelihood that displaying a targeted advertisement to a particular device of a group of devices mapped to a particular household (e.g., household graph corresponding to the household) will result in a conversion. For example, a particular mobile device may have higher influence score with respect to a different device mapped to the same household graph based on historical customer data for the particular mobile device indicating prior purchases through the mobile device. In certain embodiments, household influence determination engine 206 initially generates the influence score based on historical customer data and periodically (e.g., daily, weekly, monthly, and/or the like) updates the influence score based on updates to the customer data.

In certain embodiments, for interactions events, each step of a conversion funnel, such as clicking a product, adding a product to a cart, purchasing a product is weighted differently, and the influence score of a device is determined based on the interaction events on a corresponding device with respect to the steps of the conversion funnel by household influence determination engine 206. In certain embodiments, the weighting of each step of the conversion funnel can be manually configured by a user (e.g., an advertiser) via settings 224 of application 222 via user device 220. In certain embodiments, the influence score of each device of the group of devices of the particular household graph is determined by household influence determination engine 206 with respect to marketing campaign categories, such as a sports category, a furniture category, a gaming category, an electronics category, and/or the like. For example, a particular device may have higher influence score for a sports category and a lower influence score for a furniture category with respect to other devices of the household based on historical customer data for the particular device.

In certain embodiments, in order to determine the influence score for each device of a household graph by household influence determination engine 206, initially every device of a household graph has a constant influence score for each marketing campaign category. For each interaction event with respect to an advertisement on a corresponding device (e.g., based on historical customer data and/or in real-time using the target audience exploration engine 208), household influence determination engine 206 determines the marketing campaign category for the advertisement. Household influence determination engine 206 determines the household ID of the household graph for the corresponding device that triggered the interaction event and household influence determination engine 206 determines all of the devices for the corresponding household graph using the household ID. Household influence determination engine 206 determines all of the devices involved in the interaction and increases the influence score using the following formula:

1−(totalinteraction−memberinteraction)/totalinteraction

Where totalinteraction corresponds to the score of the total interaction event and memberinteraction corresponds to the score of the interaction event of the corresponding device. Household influence determination engine 206 then normalizes the influences score with respect to all of the devices of the household graph. The influence scores are stored in data store 218.

Target audience exploration engine 208 generally determines a target audience that includes a set of target devices for each household of a set of target households based on the influence score for the set of target devices. Target audience exploration engine 208 causes advertisement platform 201 to serve advertisements to the target audience in an exploration phase for each household until an exploration budget is met for the household and/or until the exploration phase time limit ends for the household. In this regard, the exploration phase for one household may end at a different time than a different household. For example, an advertiser inputs settings 224 through application 222 via user device 220 that includes (1) a household-level maximum frequency cap of ten (10) impressions per household, (2) an exploration budget of 30%, and (3) and an exploration phase time limit of one week. In this example, target audience exploration engine 208 causes the advertisement platform 201 to serve advertisements to the target devices (e.g., customer device 230, customer devices 112A-N of FIG. 1) of each household until the exploration budget of three (3) impressions is met for a household (and/or the period of time is over). The exploration phase for a first household may end on the first day after three (3) impressions are shown to the target devices of the first household whereas the exploration phase for a second household may end at the end of the week of the exploration phase time limit as only one (1) impression was shown to a target device of the second household. In certain embodiments, the exploration phase time limit can be manually configured by a user via settings 224 of application 222 via user device 220.

In certain embodiments, household target device selection engine 210 determines a set of target households to send an advertisement based on the corresponding devices mapped to the household graph of the household. In certain embodiments, household device selection engine 201 determines the set of target households corresponding to a threshold number of households with the highest likelihood of conversion based on historical customer data of the corresponding devices mapped to the household graph of the household. In certain embodiments, the likelihood of conversion is determined with respect to the marketing campaign category of the advertisement.

In certain embodiments, household device selection engine 210 determines a set of target devices for each household of the set of target households to send the advertisement based on the influence score for each device. In certain embodiments, household device selection engine 210 sorts the devices within each household based on the influence score for each device. Household device selection engine 210 then selects a number of devices from each household based on the summation of the influence scores of each device of the number of devices meeting a threshold cumulative influence score. For example, if the threshold cumulative influence score for each household is set to 50%, (1) for a first household, a device of the first household with an influence score of 60% can be selected as the set of target devices and (2) for a second household, a first device of the second household with an influence score of 30% and a second device of the second household with an influence score of 20% can be selected as the set of target devices. In this regard, the number of devices for the set of target devices can be different for each household of the set of target households. In certain embodiments, the threshold cumulative influence score can be manually configured by a user via settings 224 of application 222 via user device 220.

In certain embodiments, the number of devices for each household can be capped by household device selection engine 210 so that a maximum number of devices are selected for each household. Household device selection engine 210 can determine the number of devices for each household and/or the threshold cumulative influence score based on frequency capping parameters, daily budget for a number of advertisements to be sent, and/or the like.

In certain embodiments, target audience exploration engine 208 determines a device-level exploration frequency cap for each device of a set of target devices for each household of the set of target households. For example, in certain embodiments, the percentage of the exploration budget of a household assigned to a first target device of the household with a greater influence score may be greater than the percentage of the exploration budget of the household assigned to a second target device of the household with a lower influence score. In this regard, as an example, with an exploration budget of three (3) impressions for a household, the first target device may have a device-level exploration frequency cap of two (2) impression whereas the second target device may have a device-level exploration frequency cap of one (1) impression.

In certain embodiments, target audience exploration engine 208 determines the device-level exploration frequency cap based on parameters, such as the (1) exploration budget, (2) a household-level maximum frequency cap, (3) a device-level maximum frequency cap, and/or (4) the influence score of a device with respect to the cumulative influence score of the set of target devices of the household (e.g., based on a sum of the influence scores of the set of target devices of the household with respect to the influence score of the target device). In certain embodiments, parameters for determining the device-level exploration frequency cap, such as the exploration budget, household-level maximum frequency cap and device-level maximum frequency cap, can be manually configured by a user via settings 224 of application 222 via user device 220.

In certain embodiments, based on the device-level exploration frequency cap, target audience exploration engine 208 causes advertisement platform 201 to serve advertisements to each target device (e.g., customer device 230, customer devices 112A-N) of each household of the set of target households until an exploration budget is met for the household and/or until the exploration phase time limit ends for the household. In this regard, as described above, the exploration phase for one household may end at a different time than a different household.

Budget optimization engine 212 updates the set of target devices of the set of target households and/or the set of target households in response to a triggering condition, such as (1) the exploration budget being met for a target household, (2) the exploration phase time limit ending without the exploration budget being met for a target household, (3) an interaction event with respect to the advertisement after the exploration phase ends for a target household (e.g., after exploration budget is met and/or after the exploration phase time limit ends for the household), and/or (4) periodically. For example, budget optimization engine 212 can add or remove target devices from a target household and/or add or remove target households based on aggressiveness of the marketing campaign corresponding to parameters, such as optimization goals, frequency cap, campaign budget, and/or the like. In certain embodiments, budget optimization engine 212 causes the advertisement platform 201 to serve advertisements to an updated target audience to increase the likelihood of conversion of the marketing campaign. For example, the budget optimization engine 212 continues to update the target audience until a marketing campaign time limit for the advertisement ends.

In certain embodiments, dynamic update engine 214 updates the set of target devices of the set of target households and/or the set of target households in response to a triggering condition, such as (1) the exploration budget being met for a target household, (2) the exploration phase time limit ending without the exploration budget being met for a target household and/or (3) an interaction event with respect to the advertisement after the exploration phase ends for the target household. For example, after the exploration budget is met for a target household, the dynamic update engine is triggered to determine whether to (1) add or remove target devices from the target household and/or (2) remove the target household and add a new household to the set of target households. As another example, if a customer clicks on advertisement 234 through a target device (e.g., customer device 230) that received the advertisement 234 from the advertisement platform 201 after the exploration phase ends for a household, the dynamic update engine 214 is triggered to determine whether to (1) add or remove target devices from a target household and/or (2) remove the target household and add a new household to the set of target households.

In certain embodiments, dynamic update engine 214 updates the set of target devices of the set of target households and/or the set of target households in response to (1) the exploration budget being met for a target household or (2) the exploration phase time limit ending without the exploration budget being met for the target household. Initially, dynamic update engine 214 determines the household ID of the target household. Dynamic update engine 214 then determines whether to add or remove devices from the target household associated with the household ID based on the influence score of the devices involved with interaction events with respect to the influence score of the devices that received impressions. For example, dynamic update engine 214 determines a ratio of exploration success:

$$exploration success = \frac{sum of influence scores of devices ( interaction event )}{sum of influence scores of devices ( impressions )}$$

where the exploration success ratio indicates the traction this product is getting within household.

In certain embodiments, if dynamic update engine 214 determines that the exploration success ratio meets the threshold exploration success value, dynamic update engine 214 adds additional target devices to the set of target devices of the target household to update the target audience. In certain embodiments, if dynamic update engine 214 determines that the exploration success ratio is less than a threshold exploration success value, dynamic update engine 214 removes the target household and add a new household to the set of target households to update the target audience.

In some embodiments, the new household is determined by dynamic update engine 214 as the household with the next highest likelihood of conversion (e.g., as determined by household device selection engine 210) that was not previously included in the set of target households. In some embodiments, the new household is determined by dynamic update engine 214 based on similarity of the new household with households from the set of target households that resulted in a conversion (e.g., during the exploration phase via target audience exploration engine 210), such as similar influence scores of devices associated with the household graph of the new household to the households that resulted in a conversion, a similar configuration of devices types associated with the household graph of the new household to the households that resulted in a conversion, and/or the like. In certain embodiments, the threshold exploration success value can be manually configured by a user via settings 224 of application 222 via user device 220.

In certain embodiments, dynamic update engine 214 updates the set of target devices of the set of target households and/or the set of target households in response to an interaction event with respect to the advertisement after the exploration phase ends for a target household. Initially, dynamic update engine 214 determines the household ID of the device that triggered the interaction event (e.g., device on which the advertisement was clicked). Dynamic update engine 214 then determines whether to add or remove devices from the household associated with the household ID based on the influence score of the device involved with the interaction event with respect to the influence score of the devices that received impressions. For example, dynamic update engine 214 determines a ratio of interaction success:

$$interaction success = \frac{influence score of device ( interaction event )}{sum of influence scores of devices ( impressions )}$$

where the interaction success ratio indicates the traction this product is getting within household.

In certain embodiments, if dynamic update engine 214 determines that the interaction success ratio meets the threshold interaction success value, dynamic update engine 214 adds additional target devices to the set of target devices of the target household to update the target audience. In certain embodiments, if dynamic update engine 214 determines that the interaction success ratio is less than a threshold interaction success value, dynamic update engine 214 removes the target household and add a new household to the set of target households to update the target audience. In certain embodiments, the threshold interaction success value can be manually configured by a user via settings 224 of application 222 via user device 220.

In certain embodiments, periodic update engine 216 updates the set of target devices of the set of target households periodically. In certain embodiments, for each household that did not receive a threshold number of impressions within a threshold household impression time limit, periodic update engine 216 adds additional target devices to the set of target devices of the target household to update the target audience. For example, additional target devices can be added to the set of target devices of the target household to increase the likelihood of a conversion by the target household when the target household has not received enough impressions in a certain amount of time during the exploitation phase for the target household (e.g., after the exploration phase of target audience exploration engine 208 ends for the target household). In certain embodiments, the threshold number of impressions and/or the threshold household impression time limit can be manually configured by a user via settings 224 of application 222 via user device 220.

Exemplary Implementations of Dynamic Frequency Capping for Targeted Digital Advertisements

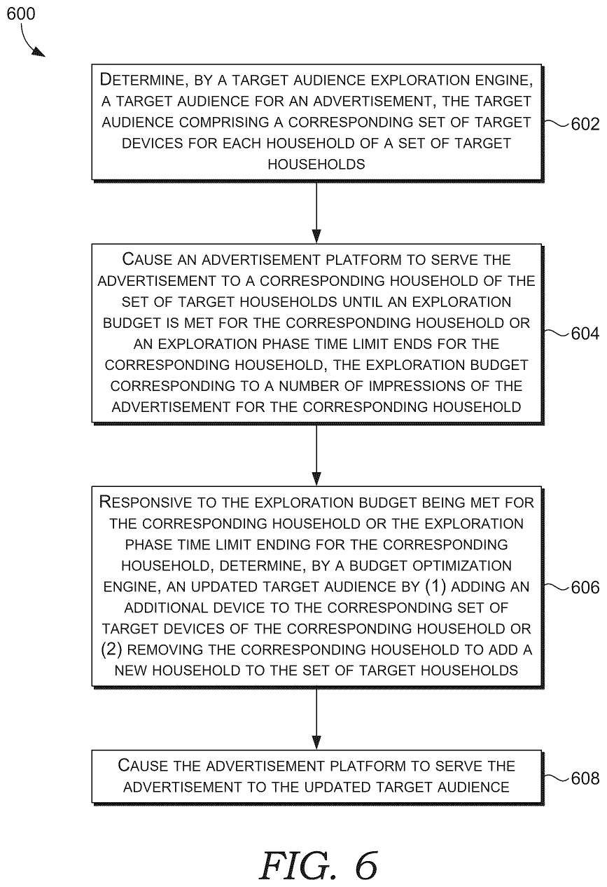

With reference now to FIGS. 6-8, flow diagrams are provided showing exemplary methods 600-800 related to dynamic frequency capping for targeted digital advertisements, in accordance with embodiments of the present technology. Each block of methods 600-800 comprises a computing process that can be performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few. The method flows of FIGS. 6-8 are exemplary only and not intended to be limiting. As can be appreciated, in some embodiments, method flows 600-800 can be implemented, at least in part, to facilitate dynamic frequency capping for targeted digital advertisements.

Turning initially to FIG. 6, a flow diagram is provided showing an embodiment of a method 600 for dynamic frequency capping for targeted digital advertisements in accordance with embodiments described herein. Initially, at block 602, a target audience exploration engine determines a target audience for an advertisement, the target audience comprising a corresponding set of target devices for each household of a set of target households. In certain embodiments, a household graph generation engine generates household graphs mapping groups of devices to particular locations using historical customer data. In certain embodiments, a household target device selection engine determines the set of target households based on corresponding historical customer data for each corresponding group devices of each household graph of each household of the set of target households. In certain embodiments, the household graph generation engine generates household graphs mapping groups of devices to particular locations using historical customer data by initially determining each corresponding household graph by mapping static devices to common IP addresses based on overlapping time windows and subsequently mapping moving devices to each corresponding household graph based on a maximum correlation between each moving device to the corresponding common IP addresses for corresponding overlapping time windows. In certain embodiments, a household influence determination engine determines a corresponding influence score of each device with respect to remaining devices of each household, the corresponding influence score corresponding to the likelihood that displaying a targeted advertisement to a particular device of a group of devices mapped to a particular household will result in a conversion. In certain embodiments, a household target device selection engine determines the corresponding set of target devices for each household based on a summation of influence scores of the corresponding set of target devices for each household meeting a threshold cumulative influence score.

At block 604, an advertisement platform serves the advertisement to a corresponding household of the set of target households until an exploration budget is met for the corresponding household or an exploration phase time limit ends for the corresponding household. The exploration budget corresponds to a number of impressions of the advertisement for the corresponding household. In certain embodiments, the exploration budget corresponds to a percentage of a household-level frequency cap. In certain embodiments, the exploration budget comprises a device-level exploration frequency cap for each device of the corresponding set of target devices of the corresponding household based on an influence score of each device with respect to remaining devices of the corresponding household.

At block 606, responsive to the exploration budget being met for the corresponding household or the exploration phase time limit ending for the corresponding household, a budget optimization engine determines an updated target audience by (1) adding an additional device to the corresponding set of target devices of the corresponding household or (2) removing the corresponding household to add a new household to the set of target households. In certain embodiments, an exploration success metric is determined based on (1) a first sum of influence scores of a first subset of the corresponding set of target devices of the corresponding household involved with interaction events with respect to (2) a second sum of influence scores of a second subset of the corresponding set of target devices of the corresponding household that received impressions. In certain embodiments, whether to (1) add the additional device to the corresponding set of target devices of the corresponding household or (2) remove the corresponding household to add the new household to the set of target households is determined based on whether the exploration success metric meets a threshold exploration success value.

At block 608, the advertisement platform serves the advertisement to the updated target audience. In certain embodiments, subsequent to the advertisement platform serving the advertisement to the updated target audience, an interaction event is received from a corresponding device of a different corresponding set of target devices of a different corresponding household. Responsive to the interaction event, the budget optimization engine determines a further updated target audience by (1) adding a corresponding additional device to the different corresponding set of target devices of the different corresponding household or (2) removing the different corresponding household to add a further new household to the updated target audience. The advertisement platform serves the advertisement to the further updated target audience. In certain embodiments, subsequent to the advertisement platform serving the advertisement to the updated target audience, a different corresponding set of target devices of a different corresponding household of the updated target audience receives less than a threshold number of impressions within a threshold household impression time limit. Responsive to the different corresponding set of target devices of the different corresponding household of the updated target audience receiving less than the threshold number of impressions within the threshold household impression time limit, the budget optimization engine determines a further updated target audience by adding a corresponding additional device to the different corresponding set of target devices of the different corresponding household. The advertisement platform serves the advertisement to the further updated target audience.

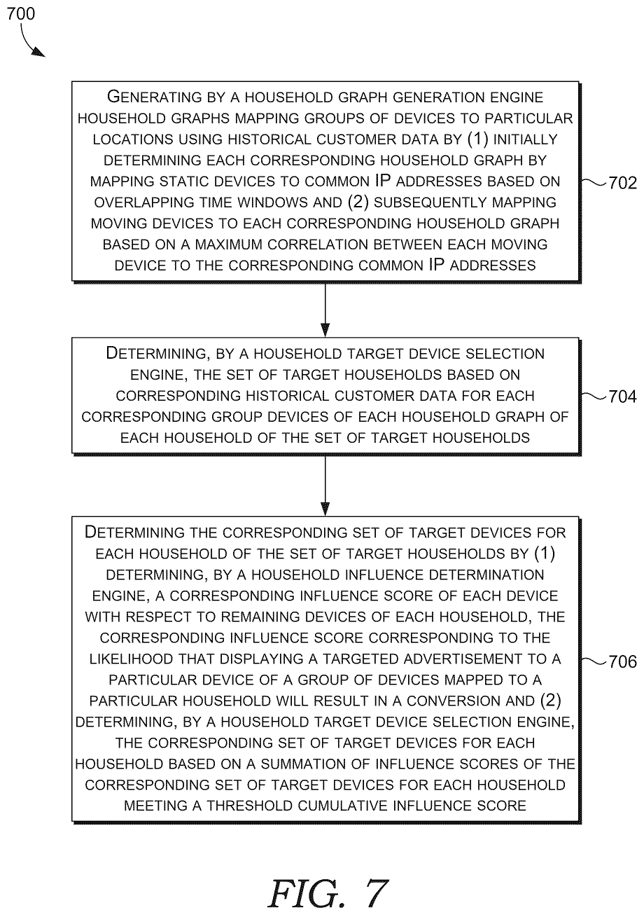

Turning now to FIG. 7, a flow diagram is provided showing an embodiment of a method 700 for dynamic frequency capping for targeted digital advertisements in accordance with embodiments described herein. Initially, at block 702, a household graph generation engine generates household graphs mapping groups of devices to particular locations using historical customer data by (1) initially determining each corresponding household graph by mapping static devices to common IP addresses based on overlapping time windows and (2) subsequently mapping moving devices to each corresponding household graph based on a maximum correlation between each moving device to the corresponding common IP addresses for corresponding overlapping time windows.

In certain embodiments, household graph generation engine generates a timeline graph for each device from historical customer data indicating each time window that the particular device was connected to a particular IP address. Examples of timeline graphs are shown in FIGS. 4-5. In certain embodiments, based on the timeline graph for each static device, household graph generation engine generates (1) nodes, where each node corresponds to the time window that the particular static device was connected to a particular IP address, and (2) edges, where each edge indicates a relationship between different IP addresses based on a common static device identifier and/or a relationship between different static device identifiers based on an overlapping time window for the same IP address. Household graph generation engine generates the household graphs based on the nodes of the static devices that are connected by corresponding edges. An example of generating household graphs based on static devices is shown in FIG. 4.

In certain embodiments, based on the timeline graph for each mobile device, household graph generation engine generates (1) nodes, where each node corresponds to the time window that the particular mobile device was connected to a particular IP address, and (2) edges, where each edge indicates a relationship between the moving device and different static device identifiers based on an overlapping time window for the same IP address and/or a relationship between different IP addresses based on a common moving device identifier. Household graph generation engine adds moving devices to corresponding household graphs based on a maximum correlation between the edges connecting a corresponding node of a corresponding moving device to corresponding nodes of the static devices of a corresponding household graph. An example of adding moving devices to corresponding household graphs generated from static devices is shown in FIG. 5.

At block 704, a household target device selection engine determines the set of target households based on corresponding historical customer data for each corresponding group devices of each household graph of each household of the set of target households. In certain embodiments, household device selection engine determines the set of target households corresponding to a threshold number of households with the highest likelihood of conversion based on historical customer data of the corresponding devices mapped to the household graph of the household. In certain embodiments, the likelihood of conversion is determined with respect to the marketing campaign category of the advertisement.

At block 706, the corresponding set of target devices for each household of the set of target households is determined by (1) determining, by a household influence determination engine, a corresponding influence score of each device with respect to remaining devices of each household, the corresponding influence score corresponding to the likelihood that displaying a targeted advertisement to a particular device of a group of devices mapped to a particular household will result in a conversion and (2) determining, by a household target device selection engine, the corresponding set of target devices for each household based on a summation of influence scores of the corresponding set of target devices for each household meeting a threshold cumulative influence score.

In certain embodiments, for interactions events, each step of a conversion funnel, such as clicking a product, adding a product to a cart, purchasing a product is weighted differently, and the influencer score of a device is determined based on the interaction events on a corresponding device with respect to the steps of the conversion funnel. In certain embodiments, the weighting of each step of the conversion funnel can be manually configured by a user (e.g., an advertiser). In certain embodiments, the influence score of each device of the group of devices of the particular household graph is determined with respect to marketing campaign categories.

In certain embodiments, in order to determine the influencer score for each device of a household graph by household influence determination engine, initially every device of a household graph has a constant influence score for each marketing campaign category. For each interaction event with respect to an advertisement on a corresponding device (e.g., based on historical customer data and/or in real-time using the target audience exploration engine), household influence determination engine determines the marketing campaign category for the advertisement. Household influence determination engine determines the household ID of the household graph for the corresponding device that triggered the interaction event and household influence determination engine determines all of the devices for the corresponding household graph using the household ID. Household influence determination engine determines all of the devices involved in the interaction and increases the influence score based on weighting of the conversion funnel step. Household influence determination engine then normalizes the influences score with respect to all of the devices of the household graph.

In certain embodiments, household device selection engine determines a set of target devices for each household of the set of target households to send the advertisement based on the influence score for each device. In certain embodiments, household device selection engine sorts the devices within each household based on the influence score for each device. Household device selection engine then selects a number of devices from each household based on the summation of the influence scores of each device of the number of devices meeting a threshold cumulative influence score. For example, if the threshold cumulative influence score for each household is set to 50%, (1) for a first household, a device of the first household with an influence score of 60% can be selected as the set of target devices and (2) for a second household, a first device of the second household with an influence score of 30% and a second device of the second household with an influence score of 20% can be selected as the set of target devices. In this regard, the number of devices for the set of target devices can be different for each household of the set of target households. In certain embodiments, the threshold cumulative influence score can be manually configured by a user.

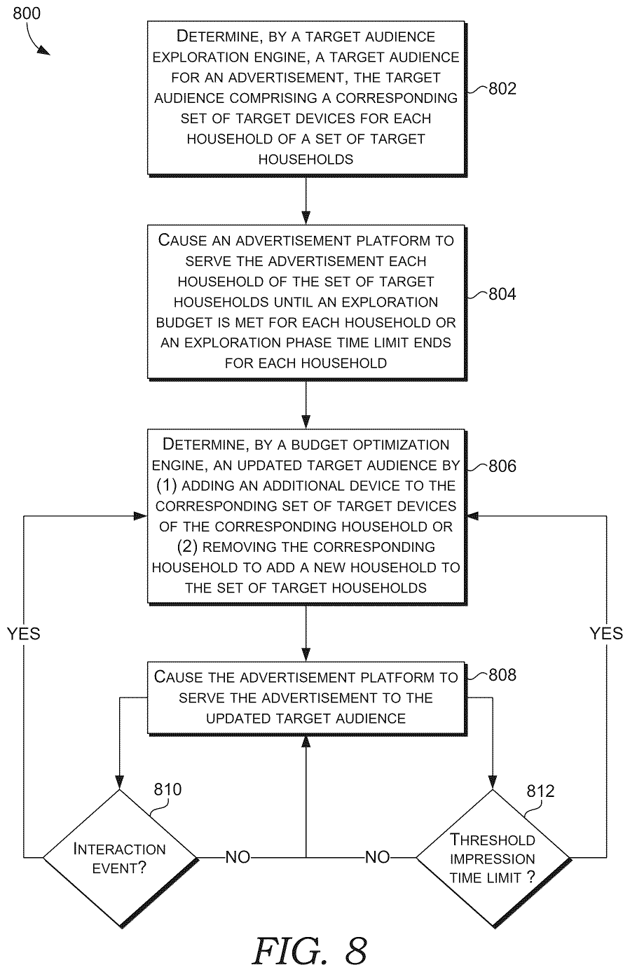

Turning now to FIG. 8, a flow diagram is provided showing an embodiment of a method 800 for dynamic frequency capping for targeted digital advertisements in accordance with embodiments described herein. Initially, at block 802, a target audience exploration engine determines a target audience for an advertisement, the target audience comprising a corresponding set of target devices for each household of a set of target households. In certain embodiments, a household graph generation engine generates household graphs mapping groups of devices to particular locations using historical customer data. In certain embodiments, a household target device selection engine determines the set of target households based on corresponding historical customer data for each corresponding group devices of each household graph of each household of the set of target households.

At block 804, in an exploration phase, an advertisement platform serves the advertisement to a corresponding household of the set of target households until an exploration budget is met for the corresponding household or an exploration phase time limit ends for the corresponding household, the exploration budget corresponding to a number of impressions of the advertisement for the corresponding household. In certain embodiments, the exploration budget corresponds to a percentage of a household-level frequency cap. In certain embodiments, the exploration budget comprises a device-level exploration frequency cap for each device of the corresponding set of target devices of the corresponding household based on an influence score of each device with respect to remaining devices of the corresponding household.

At block 806, at the end of the exploration phase for each household (e.g., responsive to the exploration budget being met for the corresponding household or the exploration phase time limit ending for the household), a budget optimization engine determines an updated target audience by (1) adding an additional device to the corresponding set of target devices of the household or (2) removing the corresponding household to add a new household to the set of target households. In certain embodiments, an exploration success metric is determined based on (1) a first sum of influence scores of a first subset of the corresponding set of target devices of the corresponding household involved with interaction events with respect to (2) a second sum of influence scores of a second subset of the corresponding set of target devices of the corresponding household that received impressions. In certain embodiments, whether to (1) add the additional device to the corresponding set of target devices of the corresponding household or (2) remove the corresponding household to add the new household to the set of target households is determined based on whether the exploration success metric meets a threshold exploration success value.

At block 808, during the exploitation phase, the advertisement platform serves the advertisement to the updated target audience. At block 810, subsequent to the advertisement platform serving the advertisement to the updated target audience, an interaction event is received during the exploitation phase from a corresponding device of a different corresponding set of target devices of a different corresponding household. Responsive to the interaction event, the budget optimization engine determines a further updated target audience by (1) adding a corresponding additional device to the different corresponding set of target devices of the different corresponding household or (2) removing the different corresponding household to add a further new household to the updated target audience. The advertisement platform serves the advertisement to the further updated target audience.

In certain embodiments, an interaction success metric is determined based on (1) an influence score of the corresponding device with respect to (2) a sum of influence scores of a subset of the corresponding set of target devices of the corresponding household that received impressions. In certain embodiments, whether to (1) add the additional device to the corresponding set of target devices of the corresponding household or (2) remove the corresponding household to add the new household to the set of target households is determined based on whether the interaction success metric meets a threshold interaction success value.

At block 812, subsequent to the advertisement platform serving the advertisement to the updated target audience, a different corresponding set of target devices of a different corresponding household of the updated target audience receives less than a threshold number of impressions within a threshold household impression time limit during the exploitation phase. Responsive to the different corresponding set of target devices of the different corresponding household of the updated target audience receiving less than the threshold number of impressions within the threshold household impression time limit, the budget optimization engine determines a further updated target audience by adding a corresponding additional device to the different corresponding set of target devices of the different corresponding household. The advertisement platform serves the advertisement to the further updated target audience.

### Overview of Exemplary Operating Environment

Having briefly described an overview of aspects of the technology described herein, an exemplary operating environment in which aspects of the technology described herein may be implemented is described below in order to provide a general context for various aspects of the technology described herein.

Referring to the drawings in general, and initially to FIG. 9 in particular, an exemplary operating environment for implementing aspects of the technology described herein is shown and designated generally as computing device 900. Computing device 900 is just one example of a suitable computing environment and is not intended to suggest any limitation as to the scope of use or functionality of the technology described herein. Neither should the computing device 900 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 9, computing device 900 includes a bus 910 that directly or indirectly couples the following devices: memory 912, one or more processors 914, one or more presentation components 916, input/output (I/O) ports 918, I/O components 920, an illustrative power supply 922, and a radio(s) 924. Bus 910 represents what may be one or more busses (such as an address bus, data bus, or combination thereof). Although the various blocks of FIG. 9 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 9 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 9 and refer to “computer” or “computing device.”

Computing device 900 typically includes a variety of computer-readable media. Computer-readable media can be any available media that can be accessed by computing device 900 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 912 includes computer storage media in the form of volatile and/or nonvolatile memory. The memory 912 may be removable, non-removable, or a combination thereof. Exemplary memory includes solid-state memory, hard drives, and optical-disc drives. Computing device 900 includes one or more processors 914 that read data from various entities such as bus 910, memory 912, or I/O components 920. Presentation component(s) 916 present data indications to a user or other device. Exemplary presentation components 916 include a display device, speaker, printing component, and vibrating component. I/O port(s) 918 allow computing device 900 to be logically coupled to other devices including I/O components 920, some of which may be built in.

Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 914 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 900. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 900. The computing device 900 may be equipped with depth cameras, such as stereoscopic camera systems, infrared camera systems, RGB camera systems, and combinations of these, for gesture detection and recognition. Additionally, the computing device 900 may be equipped with accelerometers or gyroscopes that enable detection of motion. The output of the accelerometers or gyroscopes may be provided to the display of the computing device 900 to render immersive augmented reality or virtual reality.

A computing device may include radio(s) 924. The radio 924 transmits and receives radio communications. The computing device may be a wireless terminal adapted to receive communications and media over various wireless networks. Computing device 900 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive. The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

1. A computing system comprising:
a processor; and
a non-transitory computer-readable medium having stored thereon instructions that when executed by the processor, cause the processor to perform operations including:
determining, by a target audience exploration engine, a target audience for content, the target audience comprising a corresponding set of target devices for each household of a set of target households, the corresponding set of target devices for each household corresponding to a subset of devices associated with the household;
causing a targeted content platform to serve the content to a corresponding household of the set of target households until an exploration budget is met for the corresponding household or an exploration phase time limit ends for the corresponding household, the exploration budget corresponding to a number of impressions of the content for the corresponding household;
responsive to the exploration budget being met for the corresponding household or the exploration phase time limit ending for the corresponding household, determining, by a budget optimization engine, an updated target audience by (1) adding an additional device from corresponding devices already associated with the corresponding household to the corresponding set of target devices of the corresponding household or (2) removing the corresponding household to add a new household to the set of target households; and
causing the targeted content platform to serve the content to the updated target audience.

2. The computing system of claim 1, the operations further including:
determining each household of the set of target households by:
generating, by a household graph generation engine, household graphs mapping groups of devices to particular locations using historical customer data; and
determining, by a household target device selection engine, the set of target households based on corresponding historical customer data for each corresponding group devices of each household graph of each household of the set of target households.

3. The computing system of claim 1, the operations further including:
determining each household of the set of target households by:
generating by a household graph generation engine household graphs mapping groups of devices to particular locations using historical customer data by:
initially determining each corresponding household graph by mapping static devices to common IP addresses based on overlapping time windows;
subsequently mapping moving devices to each corresponding household graph based on a maximum correlation between each moving device to the common IP addresses for corresponding overlapping time windows; and
determining, by a household target device selection engine, the set of target households based on corresponding historical customer data for each corresponding group devices of each household graph of each household of the set of target households.

4. The computing system of claim 1, the operations further including:
determining the corresponding set of target devices for each household of the set of target households by:
determining, by a household influence determination engine, a corresponding influence score of each device with respect to remaining devices of each household, the corresponding influence score corresponding to a likelihood that displaying targeted content to a particular device of a group of devices mapped to a particular household will result in a conversion; and
determining, by a household target device selection engine, the corresponding set of target devices for each household based on a summation of influence scores of the corresponding set of target devices for each household meeting a threshold cumulative influence score.

5. The computing system of claim 1, wherein the exploration budget corresponds to a percentage of a household-level frequency cap.

6. The computing system of claim 1, wherein the exploration budget comprises a device-level exploration frequency cap for each device of the corresponding set of target devices of the corresponding household based on an influence score of each device with respect to remaining devices of the corresponding household.

7. The computing system of claim 1, the operations further including:
determining whether to (1) add the additional device to the corresponding set of target devices of the corresponding household or (2) remove the corresponding household to add the new household to the set of target households by:
determining an exploration success metric based on (1) a first sum of influence scores of a first subset of the corresponding set of target devices of the corresponding household involved with interaction events with respect to (2) a second sum of influence scores of a second subset of the corresponding set of target devices of the corresponding household that received impressions; and
determining whether to (1) add the additional device to the corresponding set of target devices of the corresponding household or (2) remove the corresponding household to add the new household to the set of target households based on whether the exploration success metric meets a threshold exploration success value.

8. The computing system of claim 1, the operations further including:
responsive to an interaction event by a corresponding device of a different corresponding set of target devices of a different corresponding household of the updated target audience:
determining by the budget optimization engine, a further updated target audience by (1) adding a corresponding additional device to the different corresponding set of target devices of the different corresponding household or (2) removing the different corresponding household to add a further new household to the updated target audience; and
causing the targeted content platform to serve the content to the further updated target audience.

9. The computing system of claim 1, the operations further including:
responsive to a different corresponding set of target devices of a different corresponding household of the updated target audience receiving less than a threshold number of impressions within a threshold household impression time limit:
determining by the budget optimization engine, a further updated target audience by adding a corresponding additional device to the different corresponding set of target devices of the different corresponding household; and
causing the targeted content platform to serve the content to the further updated target audience.

10. A non-transitory computer-readable medium storing executable instructions, which when executed by a processing device, cause the processing device to perform operations comprising:
determining, by a target audience exploration engine, a target audience for an advertisement, the target audience comprising a corresponding set of target devices for each household of a set of target households, the corresponding set of target devices for each household corresponding to a subset of devices associated with the household;
causing an advertisement platform to serve the advertisement to a corresponding household of the set of target households until an exploration budget is met for the corresponding household or an exploration phase time limit ends for the corresponding household; and
subsequent to the exploration budget being met for the corresponding household or the exploration phase time limit ending for the corresponding household, responding to an interaction event by a corresponding device of the corresponding set of target devices of the corresponding household by:
determining, by a budget optimization engine, an updated target audience by (1) adding an additional device from corresponding devices already associated with the corresponding household to the corresponding set of target devices of the corresponding household or (2) removing the corresponding household to add a new household to the set of target households; and
causing the advertisement platform to serve the advertisement to the updated target audience.

11. The non-transitory computer-readable medium of claim 10, the operations further comprising:
determining each household of the set of target households by:
generating, by a household graph generation engine, household graphs mapping groups of devices to particular locations using historical customer data; and
determining, by a household target device selection engine, the set of target households based on corresponding historical customer data for each corresponding group devices of each household graph of each household of the set of target households.

12. The non-transitory computer-readable medium of claim 10, the operations further comprising:
determining each household of the set of target households by:
generating by a household graph generation engine household graphs mapping groups of devices to particular locations using historical customer data by:
initially determining each corresponding household graph by mapping static devices to common IP addresses based on overlapping time windows;
subsequently mapping moving devices to each corresponding household graph based on a maximum correlation between each moving device to the common IP addresses for corresponding overlapping time windows; and
determining, by a household target device selection engine, the set of target households based on corresponding historical customer data for each corresponding group devices of each household graph of each household of the set of target households.

13. The non-transitory computer-readable medium of claim 10, the operations further comprising:
determining the corresponding set of target devices for each household of the set of target households by:
determining, by a household influence determination engine, a corresponding influence score of each device with respect to remaining devices of each household, the corresponding influence score corresponding to a likelihood that displaying a targeted advertisement to a particular device of a group of devices mapped to a particular household will result in a conversion; and
determining, by a household target device selection engine, the corresponding set of target devices for each household based on a summation of influence scores of the corresponding set of target devices for each household meeting a threshold cumulative influence score.

14. The non-transitory computer-readable medium of claim 10, wherein the exploration budget corresponds to a percentage of a household-level frequency cap.

15. The non-transitory computer-readable medium of claim 10, wherein the exploration budget comprises a device-level exploration frequency cap for each device of the corresponding set of target devices of the corresponding household based on an influence score of each device with respect to remaining devices of the corresponding household.

16. The non-transitory computer-readable medium of claim 10, the operations further comprising:
determining whether to (1) add the additional device to the corresponding set of target devices of the corresponding household or (2) remove the corresponding household to add the new household to the set of target households by:
determining an interaction success metric based on (1) an influence score of the corresponding device with respect to (2) a sum of influence scores of a subset of the corresponding set of target devices of the corresponding household that received impressions; and
determining whether to (1) add the additional device to the corresponding set of target devices of the corresponding household or (2) remove the corresponding household to add the new household to the set of target households based on whether the interaction success metric meets a threshold interaction success value.

17. The non-transitory computer-readable medium of claim 10, the operations further comprising:
responsive to a different interaction event by a different corresponding device of a different corresponding set of target devices of a different corresponding household of the updated target audience:
determining by the budget optimization engine, a further updated target audience by (1) adding a corresponding additional device to the different corresponding set of target devices of the different corresponding household or (2) removing the different corresponding household to add a further new household to the updated target audience; and
causing the advertisement platform to serve the advertisement to the further updated target audience.

18. The non-transitory computer-readable medium of claim 10, the operations further comprising:
responsive to a different corresponding set of target devices of a different corresponding household of the updated target audience receiving less than a threshold number of impressions within a threshold household impression time limit:
determining by the budget optimization engine, a further updated target audience by adding a corresponding additional device to the different corresponding set of target devices of the different corresponding household; and
causing the advertisement platform to serve the advertisement to the further updated target audience.

19. A computer-implemented method comprising:
determining, by a target audience exploration engine, a target audience for an advertisement, the target audience comprising a corresponding set of target devices for each household of a set of target households, the corresponding set of target devices for each household corresponding to a subset of devices associated with the household;
causing an advertisement platform to serve the advertisement to a corresponding household of the set of target households until an exploration budget is met for the corresponding household or an exploration phase time limit ends for the corresponding household; and
subsequent to the exploration budget being met for the corresponding household or the exploration phase time limit ending for the corresponding household, responding to the corresponding set of target devices of the corresponding household receiving less than a threshold number of impressions within a threshold household impression time limit by:
determining, by a budget optimization engine, an updated target audience by adding an additional device from corresponding devices already associated with the corresponding household to the corresponding set of target devices of the corresponding household; and
causing the advertisement platform to serve the advertisement to the updated target audience.

20. The computer-implemented method of claim 19, further comprising:
determining each household of the set of target households by:
generating, by a household graph generation engine, household graphs mapping groups of devices to particular locations using historical customer data; and
determining, by a household target device selection engine, the set of target households based on corresponding historical customer data for each corresponding group devices of each household graph of each household of the set of target households.
